(19) United States
(12) Patent Application Publication
(10) Pub. No.: US 2020/0111105 A1
(43) Pub. Date: Apr. 9, 2020

(54) METHOD AND SYSTEM FOR TRACKING AND USING CARBON CREDITS VIA BLOCKCHAIN

(71) Applicant: MASTERCARD INTERNATIONAL INCORPORATED, Purchase, NY (US)

(72) Inventors: Pulkit Gupta, New Delhi (IN); Ashish Jain, Gurgaon (IN); Bhupinder Singh Narang, Gurgaon (IN); Shuvam Sengupta, Gurgaon (IN)

(73) Assignee: MASTERCARD INTERNATIONAL INCORPORATED, Purchase, NY (US)

(21) Appl. No.: 16/152,530

(22) Filed: Oct. 5, 2018

(51) Int. Cl. G06Q 30/00; G06Q 20/38; G06Q 20/06

(52) U.S. Cl. CPC G06Q 30/018; G06Q 2220/00; G06Q 20/065; G06Q 20/3829

(57) ABSTRACT

A method for rewarding carbon sequestration includes: receiving a carbon sequestration notification, wherein the carbon sequestration notification includes at least an amount of sequestered carbon dioxide and an entity identifier associated with an entity that sequestered the amount of sequestered carbon dioxide; receiving a verification message, wherein the verification message includes at least the entity identifier and an indication of successful verification of the entity as sequestering the amount of sequestered carbon dioxide; generating a digital signature using a private key of a cryptographic key pair; identifying a destination address associated with the entity based on at least the entity identifier; and transmitting at least the digital signature, destination address, one or more source addresses, and a currency amount based on the amount of sequestered carbon dioxide to a node in a blockchain network.

### FIELD

The present disclosure relates to the tracking and using of carbon credits via a blockchain, specifically the use of a blockchain and associated currency to incentivize and track the sequestration of carbon dioxide in the atmosphere.

### BACKGROUND

In recent years, many countries and organizations around the world have placed an emphasis on entities lowering and otherwise managing their carbon footprint, with the goal of creating an overall reduction in carbon dioxide emissions and carbon dioxide generally in the atmosphere. As part of this emphasis, some countries and organizations have begun to award entities for successfully sequestering carbon dioxide that is in the atmosphere. However, countries and organizations all have their own separate methods for tracking and incentivizing sequestration, which can cause confusion in terms of what entities have sequestered how much, and the advantages for doing so.

In addition, current methods lack transparency, which can result in a significant amount of corruption. There is a lack of standardization for the tracking and use of carbon credits for managing carbon dioxide emissions and sequestration, as well as transparency to reduce corruption and increase accuracy. These present technical challenges as divergent databases and data formats are being used on country or regional basis, requiring external mechanisms such as API or even human intervention to determine what carbon credits might apply, which increases chances of error, decreases computing efficiency and requires complex coding. Thus, there is a need for a standardized system for rewarding carbon sequestration that can provide transparency to ensure accuracy and fairness in the rewarding of carbon credits.

### SUMMARY

The present disclosure provides a description of systems and methods for rewarding carbon sequestration. A blockchain is used to store data related to the sequestration of carbon dioxide, where all entries in the blockchain are independently verified by a third party. The result is a ledger that accurately records sequestration efforts by entities in a manner that is immutable and completely transparent and auditable. As part of the blockchain, blockchain currency is awarded to sequestering entities as a predetermined amount of carbon dioxide is sequestered. This results in standardization globally regarding sequestration efforts. In addition, the use of currency as a reward allows for entities to trade the currency or cash out the currency with a participating entity, providing even more incentive for sequestration and also fostering cooperative efforts among entities, further increasing participation and the beneficial effects of carbon dioxide sequestration.

A method for rewarding carbon sequestration includes: receiving, by a receiver of a processing server, a carbon sequestration notification from a first computing system, wherein the carbon sequestration notification includes at least an amount of sequestered carbon dioxide and an entity identifier associated with an entity that sequestered the amount of sequestered carbon dioxide; receiving, by the receiver of the processing server, a verification message from a second computing system, wherein the verification message includes at least the entity identifier and an indication of successful verification of the entity as sequestering the amount of sequestered carbon dioxide; generating, by a processing device of the processing server, a digital signature using a private key of a cryptographic key pair; identifying, by the processing device of the processing server, a destination address associated with the entity based on at least the entity identifier; and transmitting, by a transmitter of the processing server, at least the digital signature, destination address, one or more source addresses, and a currency amount based on the amount of sequestered carbon dioxide to a node in a blockchain network.

A system for rewarding carbon sequestration includes: a receiver of a processing server configured to receive a carbon sequestration notification from a first computing system, wherein the carbon sequestration notification includes at least an amount of sequestered carbon dioxide and an entity identifier associated with an entity that sequestered the amount of sequestered carbon dioxide, and a verification message from a second computing system, wherein the verification message includes at least the entity identifier and an indication of successful verification of the entity as sequestering the amount of sequestered carbon dioxide; a processing device of the processing server configured to generate a digital signature using a private key of a cryptographic key pair, and identify a destination address associated with the entity based on at least the entity identifier; and a transmitter of the processing server configured to transmit at least the digital signature, destination address, one or more source addresses, and a currency amount based on the amount of sequestered carbon dioxide to a node in a blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for tracking and reward carbon sequestration in accordance with exemplary embodiments.

FIG. 2 is a block diagram illustrating the processing server of the system of FIG. 1 for tracking and reward carbon sequestration in accordance with exemplary embodiments.

FIG. 3 is a flow diagram illustrating a process for rewarding carbon sequestration executed by the processing server of FIG. 2 in accordance with exemplary embodiments.

FIG. 4 is a flow diagram illustrating a process for converting an awarded carbon credit to fiat currency executed by the processing server of FIG. 2 in accordance with exemplary embodiments.

FIG. 5 is a flow chart illustrating an exemplary method for rewarding carbon sequestration in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Rewarding Carbon Sequestration

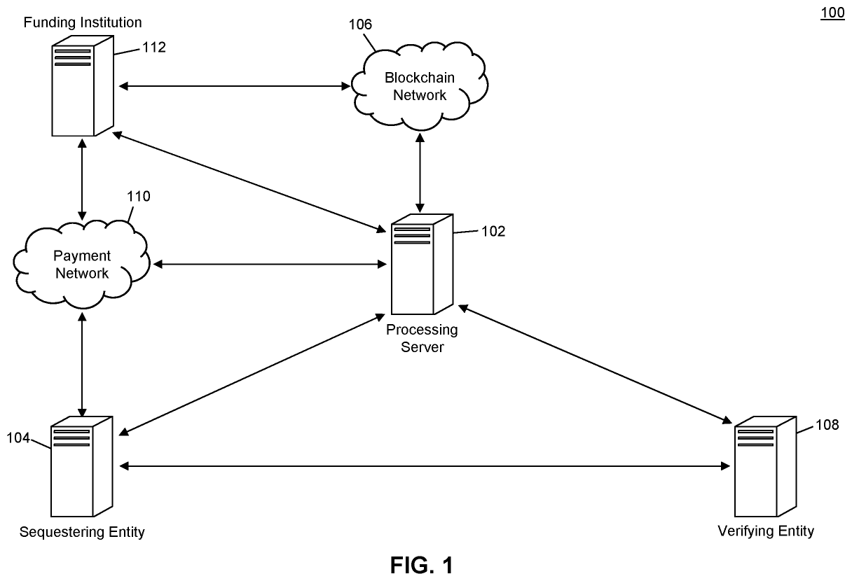

FIG. 1 illustrates a system 100 for the rewarding of the sequestration of carbon dioxide using a blockchain, where blockchain currency is rewarded to an entity for the successful sequestration of carbon dioxide and can be traded to and from other entities and cashed out through participating institutions.

The system 100 may include a processing server 102. The processing server 102, discussed in more detail below, may be configured to reward blockchain currency to a sequestering entity 104 that successfully sequesters a predetermined amount of carbon dioxide in an effort to improve the atmosphere and world environment. The system 100 may include a blockchain network 106. The blockchain network 106 may be used to manage and operate a blockchain, where the blockchain is used, as discussed in more detail below, to award blockchain currency as carbon credits to sequestering entities 104 to track and incentivize the sequestration of carbon dioxide in the atmosphere.

In the system 100, each sequestering entity 104 may have a blockchain wallet associated therewith. The blockchain wallet may be associated with the blockchain network 106 that is used to transmit and receive blockchain currency in electronic payment transactions conducted via the blockchain network 106. A blockchain wallet may be an application program that is executed by a computing device possessed by the sequestering entity 104. A blockchain wallet may include a private key of a cryptographic key pair that is used to generate digital signatures that serve as authorization by the sequestering entity 104 for a blockchain transaction, where the digital signature can be verified by the blockchain network 106 using the public key of the cryptographic key pair. In some cases, the term “blockchain wallet” may refer specifically to the private key.

The blockchain network 106 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 may be a node in the blockchain network 106. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 106 prior to the generation and addition of a new block to the blockchain in order for the change to be made permanent. Computational and communication limitations may make such a modification exceedingly difficult, if not impossible, thus rendering the blockchain immutable.

Each blockchain data value may correspond to a blockchain transaction. A blockchain transaction may consist of at least: a digital signature of the sender of currency (e.g., the processing server 102, funding institution 112, sequestering entity 104, etc.) that is generated using the sender's private key, a blockchain address of the recipient of currency generated using the recipient's public key, and a blockchain currency amount that is transferred. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. In some cases, a blockchain transaction may also include the sender's public key, for use by any entity in validating the transaction. For the processing of a blockchain transaction, such data may be provided to a node in the blockchain network 106, either by the sender or the recipient. The node may verify the digital signature and the sender's access to the funds, and then include the blockchain transaction in a new block. The new block may be validated by other nodes in the blockchain network 106 before being added to the blockchain and distributed to all of the nodes in the blockchain network 106.

In the system 100, the blockchain may be created with a predetermined amount of blockchain currency. As discussed herein, the blockchain currency may be referred to as “carbon credits.” The number of carbon credits that may exist in the blockchain upon creation may be a sufficient number such that the number of carbon credits rewarded to sequestering entities 104 will never exceed the number of carbon credits created in the blockchain. For instance, the number of carbon credits may exceed the amount of carbon dioxide in the Earth's atmosphere, such that it would be impossible for all of the carbon dioxide to be sequestered, and thus impossible for all of the credits to be awarded. The equivalence of one carbon credit to an amount of carbon dioxide may be any suitable amount, which, in some cases, may be set by the processing server 102, one or more organizations involved in the sequestration or tracking of carbon dioxide, etc. In some cases, the amount of carbon dioxide equivalent to one carbon credit may fluctuate based on the amount of carbon dioxide in the atmosphere, determinations of the marketplace, etc.

In an exemplary embodiment, the processing server 102 may possess (e.g., through a blockchain wallet thereof) all carbon credits upon creation of the blockchain. In such embodiments, the first block of the blockchain (referred to as a “genesis block”) may indicate that every possible carbon credit in the blockchain is sent to a blockchain wallet (e.g., via an address associated therewith) of the processing server 102.

When a sequestering entity 104 successfully sequesters the appropriate amount of carbon dioxide, they may apply for a carbon credit with the processing server 102. The sequestering entity 104 may submit at least a public key of their blockchain wallet or an address generated therefrom that may be used to receive a carbon credit that is awarded thereto. In some cases, the sequestering entity 104 may also submit information to be used as proof of their sequestration. When the sequestering entity 104 applies for the carbon credit, a verifying entity 108 may be required to verify the successful sequestration by the sequestering entity 104. In some cases, the sequestering entity 104 may request that a suitable verifying entity 108 provide proof to the processing server 102 as part of their application for a carbon credit. In other cases, the processing server 102 may contact a verifying entity 108 directly and request verification of the sequestration by the sequestering entity 104. For instance, the processing server 102 may select a verifying entity 108 rather than the sequestering entity 104 in an effort to stem the possibility of corruption or collusion. A verifying entity 108 may be any entity that can monitor for and evaluate the successful sequestration of carbon dioxide by a sequestering entity 104. For instance, the verifying entity 108 may be a governmental agency (e.g., the Environmental Protection Agency), a non-governmental organization (e.g., Greenpeace), or other suitable type of entity.

Once the sequestering entity 104 has applied for the carbon credit and their sequestration effort verified successfully through a verifying entity 108, the processing server 102 may award a carbon credit to the sequestering entity 104. In some cases, the sequestering entity 104 may not possess a blockchain wallet ahead of their first sequestration effort. In such cases, the processing server 102 may generate a blockchain wallet for the sequestering entity 104 and provide the private key thereof to the sequestering entity 104. In other such cases, the sequestering entity 104 may generate its own private key and provide the corresponding public key or an address generated thereby to the processing server 102.

In some embodiments, sequestering entities 104 may be required to register with the processing server 102 prior to applying for a carbon credit. The registration may include the providing of a public key of a blockchain wallet of the sequestering entity 104, as well as the providing of information from the sequestering entity 104 regarding the sequestering entity 104 and their sequestration efforts and methods. For instance, the sequestering entity 104 may provide their name, home country, country of operations, or other information that may be used in the verification of sequestration efforts and to reduce the likelihood of corruption or collusion. For example, the processing server 102 may evaluate sequestering entities 104 that apply for connections to any verifying entities 108 to prevent conflicts of interest where a single organization may operate as or have an interest in both a sequestering entity 104 and a verifying entity 108 and be able to verify or influence verification of its own applications for carbon credits.

Once a sequestering entity 104 has been registered, applied for a carbon credit, and their sequestration verified by a verifying entity 108, the processing server 102 may award a carbon credit thereto. In cases where the sequestering entity 104 provides a public key, the processing server 102 may first generate a recipient blockchain address therefrom. In other cases, the application of the sequestering entity 104 may include a recipient blockchain address. The processing server 102 may then generate a digital signature using the private key of its own blockchain wallet. The processing server 102 may submit at least the digital signature, a source address (e.g., for the genesis block), the recipient blockchain address, and the amount of carbon credits to be awarded (e.g., based on the amount of carbon dioxide that was successfully sequestered) to a node in the blockchain network 106.

The node of the blockchain network 106 may validate the digital signature supplied by the processing server 102 (e.g., using the public key of the processing server's blockchain wallet) and verify that the processing server 102 has access to the carbon credits at the source address (e.g., using the digital signature). The node may generate a blockchain data value for the awarding of the carbon credit that includes the supplied data, which may be included in a new block that is generated by the node. The node may then submit the block to other nodes in the blockchain network 106 for verification. Upon successful verification, the block may be distributed to all of the nodes in the blockchain network 106 and become part of the blockchain. In cases where the processing server 102 may be a node, the processing server 102 may generate the blockchain data value or complete block, which may be transmitted to other nodes for verification.

Successful addition of the new blockchain data value to the blockchain will result in the sequestering entity 104 having possession of the awarded carbon credit(s). The sequestering entity 104 may thus be successfully rewarded for the sequestration of carbon dioxide in the atmosphere. In an exemplary embodiment, the sequestering entity 104 may be able to transfer or trade carbon credits to other entities. In such an embodiment, a sequestering entity 104 may be awarded carbon credits for its sequestration efforts. A separate entity may make a deal with the sequestering entity 104, where the sequestering entity 104 is to pay the separate entity using a carbon credit. In such a deal, the sequestering entity 104 may submit a new transaction to a node in the blockchain network 106 (e.g., via the processing server 102 or directly to a node, which may be the processing server 102 in applicable implementations). The new transaction may include a source address for the sequestering entity 104 (e.g., used to receive the carbon credits being transferred), a digital signature generated by the sequestering entity's blockchain wallet, the amount of carbon credits being transferred, and a recipient address associated with the separate entity's blockchain wallet. The node may then validate the digital signature and sequestering entity's access to the credits being transferred, and process the blockchain transaction accordingly. The separate entity may then possess the transferred carbon credits for use thereby.

In some embodiments, sequestering entities 104 may be able to cash out their carbon credits for fiat currency. In such embodiments, the system 100 may include a funding institution 112. The funding institution 112 may be any entity that wishes to pay sequestering entities 104 for carbon credits, as additional incentive for sequestering carbon dioxide. In such embodiments, the sequestering entity 104 may transfer carbon credits that are to be cashed out to the funding institution 112 directly (e.g., where the funding institution 112 may be the separate entity in the above transaction) or may return the carbon credits to the processing server 102 (e.g., in the same manner). The funding institution 112 may agree to pay an amount of fiat currency to the sequestering entity 104 for the returned carbon credits. Along with the transfer of the carbon credits on the blockchain, the funding institution 112 (e.g., or processing server 102 as the funding institution 112 or acting on behalf thereof) may submit a payment transaction for processing to a payment network 110. The payment network 110 may receive the submitted payment transaction and process the transaction using traditional methods and systems. The processing of the payment transaction may result in the amount of fiat currency being transferred from a transaction account of the funding institution 112 to a transaction account of the sequestering entity 104, thereby providing the sequestering entity 104 with fiat currency as an award for their earned carbon credits.

In some embodiments, geographic areas may be taken into account for the functions of the system 100 discussed herein. For instance, depending on the needs of the atmosphere and/or environment, choices of the market (e.g., of sequestering entities 104, verifying entities 108, funding institutions 112, etc.), etc., the amount of carbon dioxide that must be sequestered for a carbon credit may vary based on the geographic area where the carbon is being sequestered. For example, in a geographic area where pollution is worse, the amount of carbon dioxide that must be sequestered to earn a carbon credit may be less than an area where carbon dioxide emissions are less of an issue. Geographic areas may similarly be used in the cashing out of carbon credits for fiat currency, where the geographic area of the sequestering entity 104 and/or funding institution 112 may be considered in determining the amount of fiat currency to pay for a carbon credit. In some instances, the value of a carbon credit may be tied to a single fiat currency, where the value in another fiat currency may be based on an exchange rate of another fiat currency to the single fiat currency.

The methods and systems discussed herein may enable a blockchain to be used to track and incentivize the sequestration of carbon dioxide by participating sequestering entities 104. Blockchain currency may be used as carbon credits, which may result in a standardized measurement and reward system for carbon dioxide sequestration throughout the world. The use of a blockchain ensures accuracy and transparency in the rewarding of carbon credits to reduce corruption and collusion. The immutability of a blockchain also ensures that entities cannot misrepresent or falsify their sequestration efforts, and also provides auditing of all transfers of carbon credits by sequestering entities 104, to further limit the amount of unfair influence and corruption in the sequestration of carbon dioxide. As such, the system 100 is a significant improvement over existing systems that attempt to incentivize the sequestration of carbon dioxide.

### Processing Server

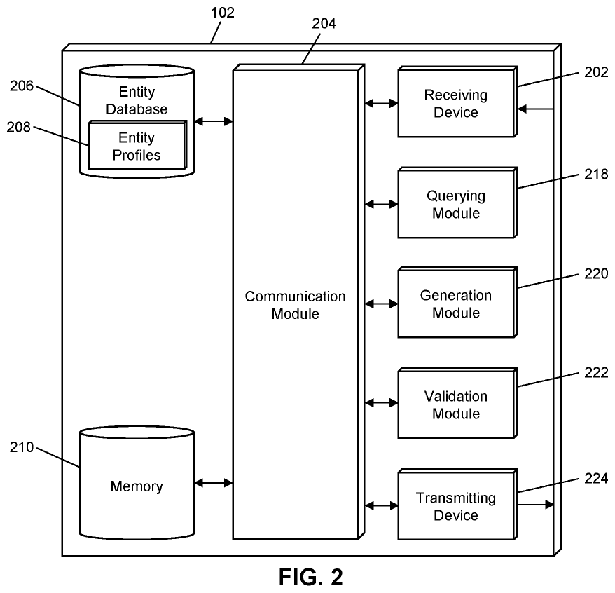

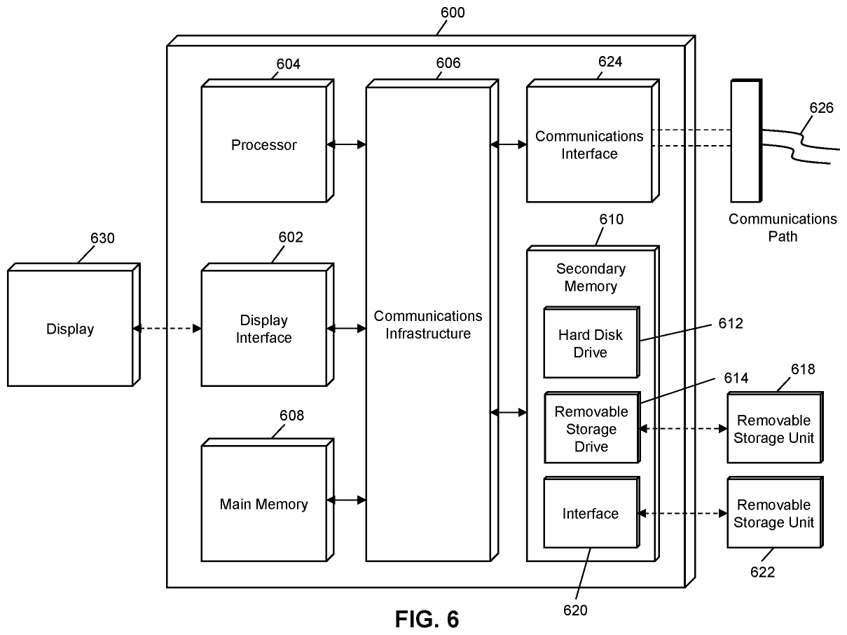

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from sequestering entities 104, verifying entities 108, blockchain networks 106, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by sequestering entities 104 that are superimposed or otherwise encoded with application for carbon credits that include public keys or addresses generated therefrom, or registration information for registering for future applications for carbon credits. The receiving device 202 may also be configured to receive data signals electronically transmitted by verifying entities 108, which may be superimposed or otherwise encoded with information used to verify carbon dioxide sequestration performed by a sequestering entity 104 as part of an application for a carbon credit thereby. The receiving device 202 may also be configured to receive data signals electronically transmitted by nodes in a blockchain network 106, which may be superimposed or otherwise encoded with notifications regarding blockchain transactions. In cases where the processing server 102 may be a node in the blockchain network 106, the receiving device 202 may be configured to receive data signals electronically transmitted by other nodes that are superimposed or otherwise encoded with blockchain data values and blocks for verification and adding to the blockchain.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, validation module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an entity database 206. The entity database 206 may be configured to store a plurality of entity profiles 208 using a suitable data storage format and schema. The entity database 206 may be a relational database that utilizes structured query language for the storage, identification, modifying, updating, accessing, etc. of structured data sets stored therein. Each entity profile 208 may be a structured data set configured to store data related to an entity in the system 100, such as a sequestering entity 104 or verifying entity 108. The entity profile 208 may include, for instance, a public key associated with the blockchain wallet of the related entity, registration information, a geographic area associated therewith, biographical information for use in obtaining verifications for sequestrations, etc.

The processing server 102 may include a querying module 218. The querying module 218 may be configured to execute queries on databases to identify information. The querying module 218 may receive one or more data values or query strings, and may execute a query string based thereon on an indicated database, such as the entity database 206, to identify information stored therein. The querying module 218 may then output the identified information to an appropriate engine or module of the processing server 102 as necessary. The querying module 218 may, for example, execute a query on the entity database 206 to identify if an entity profile 208 associated with a sequestering entity 104 that applied for a carbon credit to identify a public key stored therein for generating a recipient blockchain address, and for identifying biographical information for use in requesting verification of sequestration from a verifying entity 108 for the sequestering entity 104.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to sequestering entities 104 and verifying entities 108, such as prompts for digital signatures, registration data, sequestration verifications, etc., as well as for transmission to nodes in the blockchain network 106, such as for a new blockchain transaction to be processed. The generation module 220 may also be configured to generate digital signatures and blockchain addresses using private and public keys, respectively, using suitable algorithms.

The processing server 102 may also include a validation module 222. The validation module 222 may be configured to validate data for the processing server 102 as part of the functions discussed herein. The validation module 222 may receive data to be validated as input, may attempt validation of the data, and may output a result of the attempted validation. In some cases, the validation module 222 may be provided with other data to be used in the validation. In other cases, the validation module 222 may be configured to identify (e.g., with the use of other modules and memory, such as the querying module 218 and entity database 206) other data to be used in the validation. The validation module 222 may be configured to, for example, validate digital signatures using public keys and appropriate signature generation algorithms.

The processing server 102 may also include a transmitting device 224. The transmitting device 224 may be configured to transmit data over one or more networks via one or more network protocols. In some instances, the transmitting device 224 may be configured to transmit data to sequestering entities 104, blockchain networks 106, verifying entities 108, payment networks 110, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to sequestering entities 104 that are superimposed or otherwise encoded with requests for registration data or digital signatures, verifications of blockchain transactions or fiat currency payment transactions, etc. The transmitting device 224 may also be configured to electronically transmit data signals to verifying entities 108 that are superimposed or otherwise encoded with requests for verification of sequestration by a sequestering entity 104, which may include data associated therewith received in an application for a carbon credit or identified in a related entity profile 208. The transmitting device 224 may also be configured to electronically transmit data signals to nodes in a blockchain network 106, which may be superimposed or otherwise encoded with new blockchain data values or blocks for validation and adding to the blockchain associated therewith. The transmitting device 224 may also be configured to electronically transmit data signals to a payment network 110 via payment rails associated therewith, which may be superimposed or otherwise encoded with an authorization request for the processing of a payment transaction for payment of fiat currency to a sequestering entity 104 in exchange for an awarded carbon credit.

The processing server 102 may also include a memory 210. The memory 210 may be configured to store data for use by the processing server 102 in performing the functions discussed herein, such as public and private keys, symmetric keys, etc. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein. The memory 210 may be configured to store, for example, blockchain data, hashing algorithms for generating blocks, credentials for validation, usage rule templates, communication data for blockchain nodes, routing information for transaction messages, transaction message formatting standards, currency exchange rate data and algorithms, carbon dioxide amounts for geographic areas, sequestration rules and data, etc.

### Process for Rewarding Carbon Sequestration

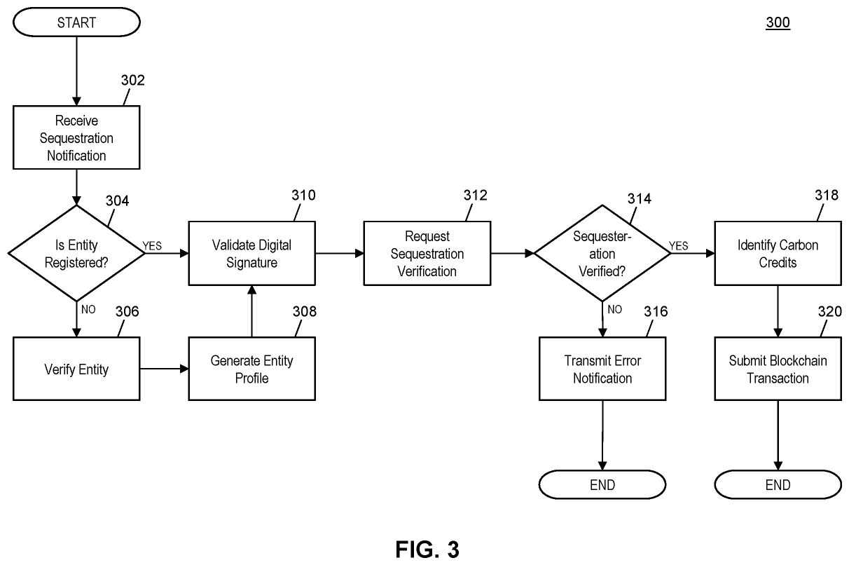

FIG. 3 illustrates an example process 300 for the rewarding of a sequestering entity 104 in the system 100 for the successful sequestration of carbon dioxide as executed by the processing server 102 in the system 100 and illustrated in FIG. 2, as discussed above.

In step 302, the receiving device 202 of the processing server 102 may receive a sequestration notification from a sequestering entity 104. The sequestration notification may be an application for one or more carbon credits based on the sequestration of carbon dioxide performed by the sequestering entity 104. The notification may include at least information regarding the carbon dioxide that was sequestered, such as an amount of carbon dioxide, geographic area, method used, etc. In step 304, the processing server 102 may determine if the sequestering entity 104 was previously registered with the processing server 102. The determination may be based on data included in the sequestration notification, such as the existence of a public key for a blockchain wallet associated with the sequestering entity 104. If the sequestering entity 104 is not registered, then, in step 306, the processing server 102 may verify the identity of the sequestering entity 104, such as based on the data included in the sequestration notification. In some cases, verification of the identity of the sequestering entity 104 may include contacting a verifying entity 108 to verify that the entity posing as the sequestering entity 104 is the actual sequestering entity 104 they are purporting to be.

In step 308, the querying module 218 of the processing server 102 may insert a new entity profile 208 in the entity database 206 of the processing server 102 for the sequestering entity 104. The new entity profile 208 may include registration data of the sequestering entity 104 as well as a public key of a cryptographic key pair that comprises the blockchain wallet of the sequestering entity 104. In some cases, the generation module 220 of the processing server 102 may generate the cryptographic key pair, where the private key may be provided to the sequestering entity 104 (e.g., via a transmission by the transmitting device 224 of the processing server 102). In other cases, the sequestering entity 104 may supply the public key to the processing server 102.

Once the sequestering entity 104 has been registered or if the sequestering entity 104 was already registered ahead of submitting the application for the carbon credit, then, in step 310, the validation module 222 of the processing server 102 may validate a digital signature included in the sequestration notification, which was generated using the private key of the sequestering entity's blockchain wallet. In cases where the sequestering entity 104 did not receive the private key until step 308, step 310 may include the receipt of a newly-generated digital signature provided by the sequestering entity 104. In step 312, the transmitting device 224 of the processing server 102 may electronically transmit a request to a verifying entity 108 requesting verification of the sequestration of carbon dioxide performed by the sequestering entity 104. The request may include at least data identifying the sequestering entity 104 and any data provided thereby in the sequestration notification.

In step 314, the receiving device 202 of the processing server 102 may receive a verification result from the verifying entity 108, which may indicate if the sequestration alleged by the sequestering entity 104 was successfully verified. If the sequestration was not verified, then, in step 316, the transmitting device 224 of the processing server 102 may electronically transmit an error notification to the sequestering entity 104, informing the sequestering entity 104 that the sequestration was unable to be verified. In some cases, the sequestering entity 104 may be provided with an opportunity to provide alternative data for use in verifying the sequestration. In some instances, the processing server 102 may contact multiple verifying entities 108 prior to making a final decision on the success of verification in step 314, such as for getting a second opinion or additional verification.

If the sequestration was successfully verified, then, in step 318, the processing server 102 may identify an amount of carbon credits that are to be awarded to the sequestering entity 104 based on the amount of carbon dioxide that was verified as being sequestered thereby. In step 320, the transmitting device 224 of the processing server 102 may electronically transmit transaction data for a blockchain transaction to a node in the blockchain network 106, where the transaction data may include at least the identified amount of carbon credits, a digital signature generated using a private key of the processing server 102, a source blockchain address, and a destination blockchain address generated using the public key of the sequestering entity's blockchain wallet. The node may then process the blockchain transaction, which may result in the sequestering entity 104 having possession of the awarded carbon credit(s).

### Process for Cashing Out an Awarded Carbon Credit

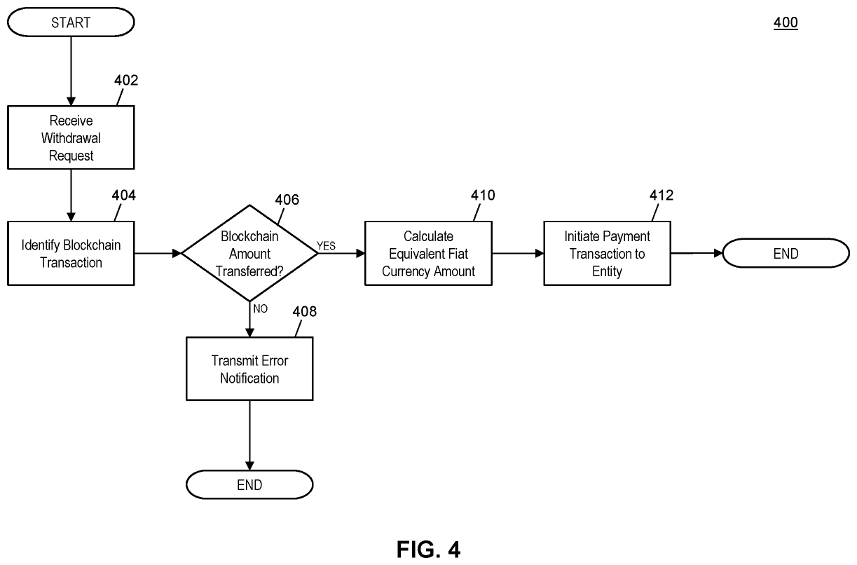

FIG. 4 illustrates a process 400 executed by the processing server 102 of FIG. 2 in the system 100 for facilitating the cashing out of a carbon credit by the sequestering entity 104, such as awarded in the process 300 illustrated in FIG. 3 and discussed above.

In step 402, the receiving device 202 of the processing server 102 may receive a withdrawal request from a sequestering entity 104. The withdrawal request may include at least an amount of carbon credits being cashed out and account data for a transaction account to be used to receive funds for the withdrawal. In step 404, the processing server 102 may identify a successfully processed blockchain transaction for transfer of the amount of carbon credits from the sequestering entity 104 to the processing server 102. In some embodiments, the blockchain transaction may have been previously processed. In such embodiments, the withdrawal request may include an identifier or other value for use by the processing server 102 in identifying the processed transaction. In other embodiments, the withdrawal request may further include a digital signature generated by the private key of the sequestering entity's blockchain wallet and a source address for the location of the carbon credits being cashed out, where the processing server 102 may initiate the blockchain transaction with a node in the blockchain network 106 for transfer of the selected amount of carbon credits to the processing server 102.

In step 406, the processing server 102 may determine if such a transaction was successfully found and that it was for the value attempted to be cashed out by the sequestering entity 104. If the determination was unsuccessful (e.g., the transfer never occurred or was for an insufficient amount of carbon credits), then, in step 408, the transmitting device 224 of the processing server 102 may electronically transmit an error notification to the sequestering entity 104 accordingly. In some cases, the sequestering entity 104 may be provided with an opportunity to provide alternative information and repeat the process 400.

If, in step 406, the determination was successful such that the processing server 102 received the sufficient amount of carbon credits from the sequestering entity 104, then, in step 410, the processing server 102 may calculate an amount of fiat currency equivalent to the carbon credits transferred by the sequestering entity 104. In some cases, the withdrawal request may specify the fiat currency to be used. In other cases, the fiat currency may be predetermined (e.g., set by the processing server 102 for all withdrawals) or may be selected based on biographical information of the sequestering entity 104 (e.g., the sequestering entity's home country as specified in their entity profile 208 in the entity database 206). In step 412, the transmitting device 224 of the processing server 102 may electronically transmit an authorization request to a payment network 110 for initiation and processing of a payment transaction for payment of the calculated amount of fiat currency to the sequestering entity 104 via the transaction account associated with the account data included in the withdrawal request. In some cases, payment may be made from a funding institution 112. In such cases, the authorization request may include account data associated with a transaction account of the funding institution 112 as the account being used to fund the payment transaction.

### Exemplary Method for Rewarding Carbon Sequestration

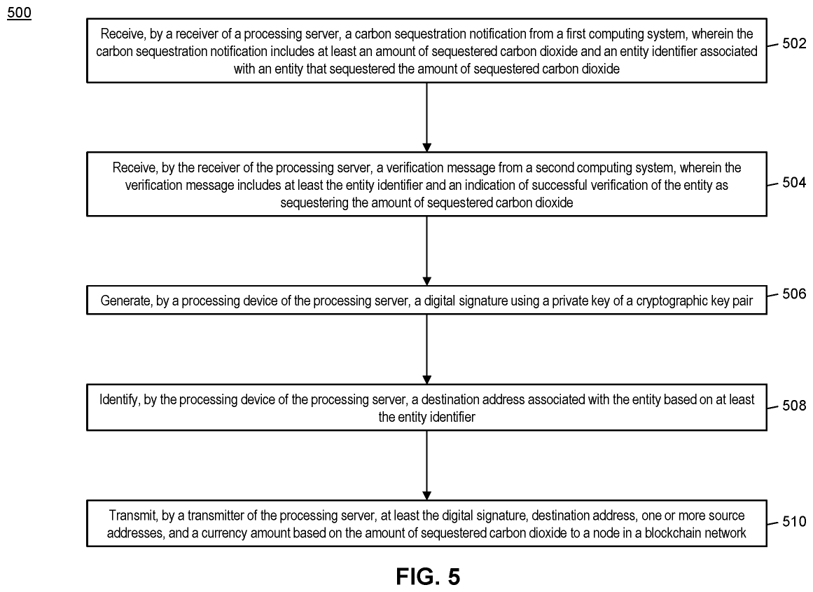

FIG. 5 illustrates a method 500 for the reward of carbon credits to an entity for the successful sequestration of carbon dioxide through blockchain currency in a blockchain network.

In step 502, a carbon sequestration notification may be received from a first computing system (e.g., the sequestering entity 104) by a receiver (e.g., the receiving device 202) of a processing server (e.g., the processing server 102), wherein the carbon sequestration notification includes at least an amount of sequestered carbon dioxide and an entity identifier associated with an entity that sequestered the amount of sequestered carbon dioxide. In step 504, a verification message may be received by the receiver of the processing server from a second computing system (e.g., the verifying entity 108), wherein the verification message includes at least the entity identifier and an indication of successful verification of the entity as sequestering the amount of sequestered carbon dioxide.

In step 506, a digital signature may be generated by a processing device (e.g., the generation module 220) of the processing server using a private key of a cryptographic key pair. In step 508, a destination address associated with the entity may be identified by the processing device (e.g., the querying module 218) of the processing server based on at least the entity identifier. In step 510, at least the digital signature, destination address, one or more source addresses, and a currency amount based on the amount of sequestered carbon dioxide may be transmitted by a transmitter (e.g., the transmitting device 224) of the processing server to a node in a blockchain network (e.g., the blockchain network 106).

In one embodiment, the method 500 may further include storing, in a memory (e.g., the memory 210) of the processing server, the private key of the cryptographic key pair. In some embodiments, each of the one or more source addresses may be generated using a public key of the cryptographic key pair. In one embodiment, the entity identifier may be a public key of a key pair associated with the entity, and identifying the destination address may include generating the destination address using the public key. In some embodiments, the method 500 may also include storing, in a memory (e.g., the entity database 206) of the processing server, an entity profile (e.g., an entity profile 208) associated with the entity, wherein the entity profile includes at least the entity identifier and a public key of a key pair associated with the entity, wherein identifying the destination address includes generating the destination address using the public key.

In one embodiment, the carbon sequestration notification may further include a geographic area, and the currency amount may be further based on the geographic area. In some embodiments, the method 500 may further include: receiving, by the receiver of the processing server, a withdrawal request, wherein the withdrawal request includes at least a specified blockchain amount and a transaction account number; and initiating, by the processing device of the processing server, a payment transaction for payment of an amount of fiat currency based on the specified blockchain amount from a first transaction account to a second transaction account, wherein the second transaction account is associated with the transaction account number. In a further embodiment, the withdrawal request may further include a transaction notification, the transaction notification may include an identification value associated with a blockchain transaction, and the blockchain transaction may include a recipient address generated using a public key of the cryptographic key pair and the specified blockchain amount.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for rewarding carbon sequestration. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for rewarding carbon sequestration, comprising:
receiving, by a receiver of a processing server, a carbon sequestration notification from a first computing system, wherein the carbon sequestration notification includes at least an amount of sequestered carbon dioxide and an entity identifier associated with an entity that sequestered the amount of sequestered carbon dioxide;
receiving, by the receiver of the processing server, a verification message from a second computing system, wherein the verification message includes at least the entity identifier and an indication of successful verification of the entity as sequestering the amount of sequestered carbon dioxide;
generating, by a processing device of the processing server, a digital signature using a private key of a cryptographic key pair;
identifying, by the processing device of the processing server, a destination address associated with the entity based on at least the entity identifier; and
transmitting, by a transmitter of the processing server, at least the digital signature, destination address, one or more source addresses, and a currency amount based on the amount of sequestered carbon dioxide to a node in a blockchain network.

2. The method of claim 1, further comprising:
storing, in a memory of the processing server, the private key of the cryptographic key pair.

3. The method of claim 1, wherein each of the one or more source addresses was generated using a public key of the cryptographic key pair.

4. The method of claim 1, wherein
the entity identifier is a public key of a key pair associated with the entity, and
identifying the destination address includes generating the destination address using the public key.

5. The method of claim 1, further comprising:
storing, in a memory of the processing server, an entity profile associated with the entity, wherein the entity profile includes at least the entity identifier and a public key of a key pair associated with the entity, wherein
identifying the destination address includes generating the destination address using the public key.

6. The method of claim 1, wherein
the carbon sequestration notification further includes a geographic area, and
the currency amount is further based on the geographic area.

7. The method of claim 1, further comprising:
receiving, by the receiver of the processing server, a withdrawal request, wherein the withdrawal request includes at least a specified blockchain amount and a transaction account number; and
initiating, by the processing device of the processing server, a payment transaction for payment of an amount of fiat currency based on the specified blockchain amount from a first transaction account to a second transaction account, wherein the second transaction account is associated with the transaction account number.

8. The method of claim 7, wherein
the withdrawal request further includes a transaction notification,
the transaction notification includes an identification value associated with a blockchain transaction, and
the blockchain transaction includes a recipient address generated using a public key of the cryptographic key pair and the specified blockchain amount.

9. A system for rewarding carbon sequestration, comprising:
a receiver of a processing server configured to receive
a carbon sequestration notification from a first computing system, wherein the carbon sequestration notification includes at least an amount of sequestered carbon dioxide and an entity identifier associated with an entity that sequestered the amount of sequestered carbon dioxide, and
a verification message from a second computing system, wherein the verification message includes at least the entity identifier and an indication of successful verification of the entity as sequestering the amount of sequestered carbon dioxide;
a processing device of the processing server configured to
generate a digital signature using a private key of a cryptographic key pair, and
identify a destination address associated with the entity based on at least the entity identifier; and
a transmitter of the processing server configured to transmit at least the digital signature, destination address, one or more source addresses, and a currency amount based on the amount of sequestered carbon dioxide to a node in a blockchain network.

10. The system of claim 9, further comprising:
a memory of the processing server configured to store the private key of the cryptographic key pair.

11. The system of claim 9, wherein each of the one or more source addresses was generated using a public key of the cryptographic key pair.

12. The system of claim 9, wherein
the entity identifier is a public key of a key pair associated with the entity, and
identifying the destination address includes generating the destination address using the public key.

13. The system of claim 9, further comprising:
a memory of the processing server configured to store an entity profile associated with the entity, wherein the entity profile includes at least the entity identifier and a public key of a key pair associated with the entity, wherein
identifying the destination address includes generating the destination address using the public key.

14. The system of claim 9, wherein
the carbon sequestration notification further includes a geographic area, and
the currency amount is further based on the geographic area.

15. The system of claim 9, wherein
the receiver of the processing server is further configured to receive a withdrawal request, wherein the withdrawal request includes at least a specified blockchain amount and a transaction account number, and
the processing device of the processing server is further configured to initiate a payment transaction for payment of an amount of fiat currency based on the specified blockchain amount from a first transaction account to a second transaction account, wherein the second transaction account is associated with the transaction account number.

16. The system of claim 15, wherein
the withdrawal request further includes a transaction notification,
the transaction notification includes an identification value associated with a blockchain transaction, and
the blockchain transaction includes a recipient address generated using a public key of the cryptographic key pair and the specified blockchain amount.
